(19) United States
(12) Patent Application Publication
(10) Pub. No.: US 2013/0326904 A1
(43) Pub. Date: Dec. 12, 2013

(54) Method of Controlling a Rotatable-Drum Laundry Drier and a Rotatable-Drum Laundry Drier Implementing the Method

(71) Applicants: Fabio Altinier, Codogne (IT); Michele Bisaro, Spilimbergo (IT); Roberto Ragogna, Malnisio (IT)

(72) Inventors: Fabio Altinier, Codogne (IT); Michele Bisaro, Spilimbergo (IT); Roberto Ragogna, Malnisio (IT)

(73) Assignee: ELECTROLUX HOME PRODUCTS CORPORATION N.V., Brussels (BE)

(21) Appl. No.: 13/989,907

(22) PCT Filed: Nov. 25, 2011
(86) PCT No.: PCT/EP11/71078

§ 371 Date: Aug. 26, 2013

(30) Foreign Application Priority Data
Nov. 29, 2010 (EP) 10192900.8

(51) Int. Cl. F26B 3/02; F26B 25/16

(52) U.S. Cl. CPC F26B 3/02; F26B 25/16
USPC 34/499; 34/88

(57) ABSTRACT

A method is provided for controlling a rotatable-drum laundry drier (1) for drying laundry. The rotatable-drum laundry drier (1) has a rotatable drum (3) for laundry (5) and moisture sensors (22) generating an electrical signal (SM) indicative: of the loaded laundry moisture/quantity. The method includes the steps of: feeding a flow of air into the drum (3) so that it blows on the laundry (3), rotating the drum (3) about an axis of rotation (6), calculating the quantity and/or weight of the laundry on the basis of a first quantity (OFFSET) indicative of the behaviour of the electrical signal (SM) in a predetermined initial measuring interval (TTM) of the drying cycle, determining a main cycle interval (TTC) indicative of the time that the electrical signal (SM) takes from the beginning of the drying cycle to meet a relation with a predetermined threshold (TSH), extending the main cycle interval (TTC) on the basis of the calculated quantity/weight of the laundry and the determined main cycle interval (TTC), and interrupting the drying cycle at the end of the extended main cycle interval (TEND).

The present invention relates to a method of controlling a rotatable-drum laundry drier and a rotatable-drum laundry drier implementing the method.

Methods of controlling rotatable-drum laundry driers are known, in which: hot air is fed into the rotating drum so as to flow over the laundry inside; the impedance of the laundry is measured by measuring electrodes positioned contacting the laundry; the moisture of the laundry is determined on the basis of the impedance measurement; and the drying cycle is stopped when the impedance measurement reaches a certain value associated with a predetermined final moisture.

If the above-described control methods are, on the one hand, able to perform uniform drying on some types of laundry, such as, for example, low quantities of cotton laundry, on the other hand, they do not guarantee the same drying uniformity with other types of laundry having large sizes/high thicknesses, such as, for example, cushions, duvets, blankets etc., or laundry comprising articles in so-called “special” fabrics, such as the material sold under the trademark “GORETEX” or similar fabrics.

In particular, the structure and/or size and/or type of fabric that characterizes the above-mentioned laundry cause more rapid drying of the outer surface of the laundry compared to the drying of its inner part when the hot airflow blows on the laundry.

Since the above-described control methods calculate the end time of the drying cycle on the basis of the electrical signal generated by the contact of the measuring electrodes with the outer surface of the laundry, the drying cycle ends early with respect to the time when uniform drying of the laundry would be achieved, thereby causing incomplete drying of an inner portion of the laundry that, in consequence, remains damp.

In-depth research has been carried out by the Applicant to provide a simple and inexpensive solution that will enable guaranteeing the user to achieve a final, uniform moisture value, both in the inner part and in the outer surface of the laundry, even when the latter corresponds to a type of laundry characterized by a different inner/outer drying capacity and/or is made of a so-called “special” fabric of the above-mentioned type.

It is therefore an object of the present invention to provide a solution designed to achieve the above goals.

According to the present invention, there is provided a method of controlling a rotatable-drum laundry drier comprising a drum for loading laundry, and moisture sensors generating an electrical signal related to the moisture/quantity of the loaded laundry, the method comprising the steps of:
feeding drying air into the drum;
rotating the drum about an axis of rotation;
calculating the quantity/weight of the laundry on the basis of a first quantity related to the behaviour of the electrical signal in a predetermined initial measuring interval of the drying cycle;
calculating a main cycle interval related to the time that the electrical signal takes from the beginning of the drying cycle to meet a determined relation with a threshold;
extending the main cycle interval on the basis of the calculated quantity/weight of the laundry and of the determined main cycle interval;
stopping the drying cycle at the end of the extended main cycle interval.

Preferably the first quantity is indicative of the mean value of the amplitude of the electrical signal during the predetermined initial measuring interval.

Advantageously the initial measuring interval is between approximately 1 and 5 minutes.

Preferably the initial measuring interval is approximately 2 minutes.

Advantageously the method comprises the step of storing in memory means of the rotatable-drum laundry drier:
a plurality of first values, each of which is associated to a value or range of values of the first quantity;
a plurality of second values, each of which is indicative of a main cycle interval and is associated with a value or range of values of the first quantity;
a plurality of third values, each of which is indicative of a multiplication factor and is associated with a value or a range of values of the main cycle interval and with a value or range of values of the first quantity.

Preferably the method comprises the steps of:
determining a first value on the basis of the value of the first quantity measured during the initial measuring interval;
determining a second value on the basis of the calculated main cycle interval;
determining a third value, corresponding to a multiplication factor, on the basis of the determined first and second values; and
extending the main cycle interval (TTC) by multiplying the main cycle interval by the determined third value associated with the multiplication factor.

Advantageously the method comprises the step of calculating the quantity/weight of laundry as a function of the first value, and adjusting the duration of a cooling phase of the laundry following the drying cycle end time as a function of the calculated weight/quantity of the laundry.

The invention also relates to a rotatable-drum laundry drier comprising:
a rotatable drum for laundry,
moisture sensors configured to generate an electrical signal related to the moisture/quantity of the laundry,
feeding drying air means for feeding drying air into the drum, and
means for rotating the drum about an axis of rotation;

the rotatable-drum laundry drier comprises electronic control means configured to:
calculate the quantity/weight of the laundry on the basis of a first quantity indicative of the behaviour of the electrical signal in an predetermined initial measuring interval of the drying cycle;
determining a main cycle interval indicatives of the time that the electrical signal takes from the beginning of the drying cycle to meet a determined relation with a threshold;
extending the main cycle interval on the basis of the calculated quantity/weight of the laundry and the determined main cycle interval, and
stopping the drying cycle at the end of the extended main cycle interval.

Advantageously, in the rotatable-drum laundry drier according to the invention the electronic control means are configured to calculate the quantity/weight of the laundry on the basis of a first quantity that is indicative of the mean value of the amplitude of the electrical signal during the predetermined initial measuring interval.

Preferably, in the rotatable-drum laundry drier according to the invention the initial measuring interval is between approximately 1 and 5 minutes.

Opportunely, in the rotatable-drum laundry drier according to the invention the initial measuring interval is approximately 2 minutes.

Preferably, the rotatable-drum laundry drier according to the invention comprises memory means containing:
a plurality of first values, each of which is associated to a value or range of values of the first quantity;
a plurality of second values, each of which is indicative of a main cycle interval and is associated with a value or range of values of the first quantity;
a plurality of third values, each of which is indicative of a multiplication factor and is associated with a value or a range of values of the main cycle interval and with the value or range of values of the first quantity.

Advantageously in the rotatable-drum laundry drier according to the invention the electronic control means are configured to:
determine a first value on the basis of the value of the first quantity measured during the initial measuring interval;
determine a second value on the basis of the calculated main cycle interval;
determine a third value, corresponding to a multiplication factor, on the basis of the determined first and second values; and
extend the main cycle interval by multiplying the main cycle interval by the determined third value associated with the multiplication factor.

Preferably in the rotatable-drum laundry drier according to the invention the electronic control means are configured to calculate the quantity/weight of laundry as a function of the first value, and to adjust the duration of a cooling phase of the laundry following the drying cycle end time as a function of the calculated weight/quantity of the laundry.

The invention advantageously regards also an electronic control system of a rotatable-drum laundry drier comprising electronic control means configured to implement the control method according to the invention.

A non-limiting embodiment of the present invention will be described by way of example with reference to the accompanying drawings, in which:

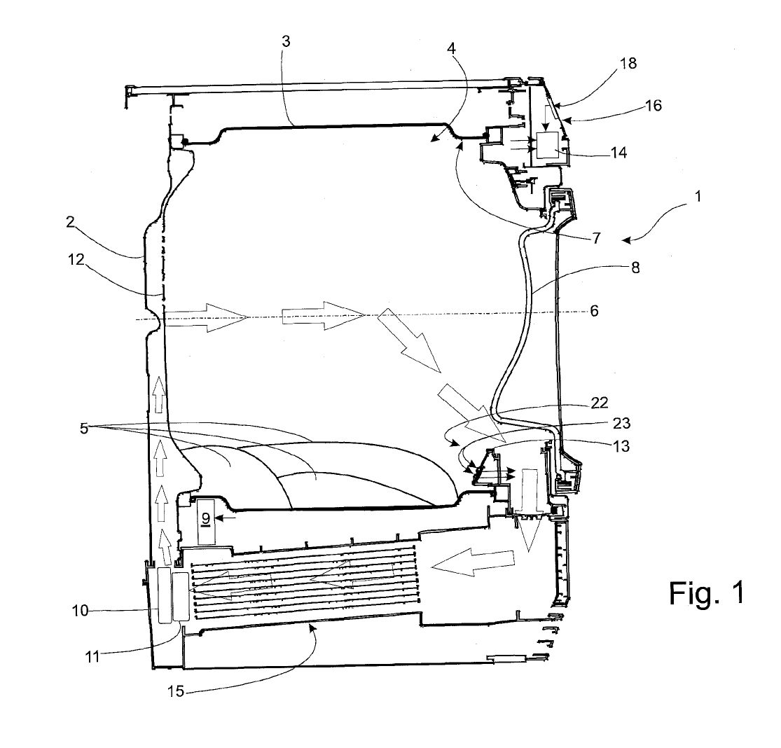

FIG. 1 shows a schematic lateral cross section of a rotatable-drum laundry drier implementing the laundry drying control method according to the present invention;

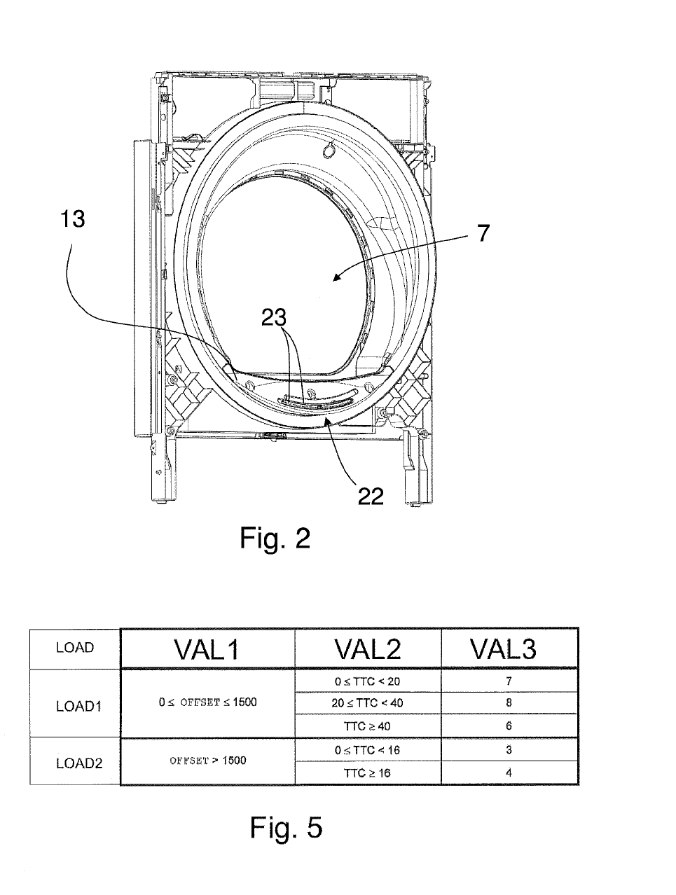

FIG. 2 shows an inner lateral wall of the FIG. 1 rotatable-drum laundry drier, housing moisture measuring sensors/electrodes;

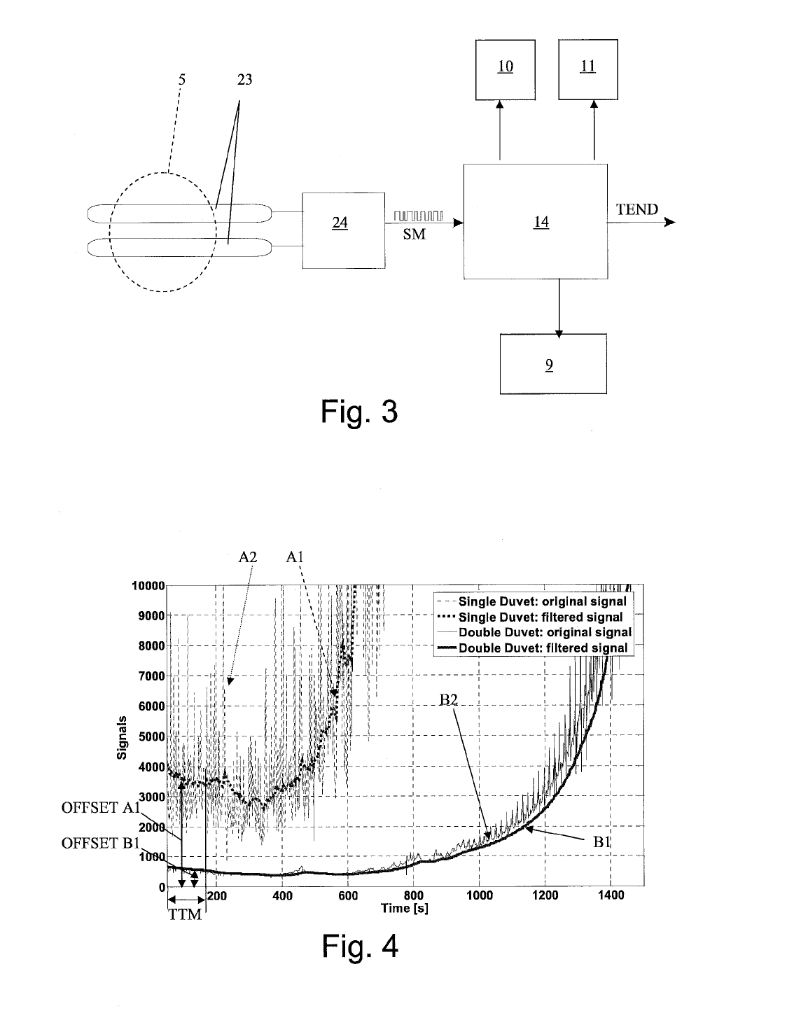

FIG. 3 is a block diagram of some electronic components of the electronic control system of the rotatable-drum laundry drier shown in FIG. 1,

FIG. 4 shows an example of an electrical signal generated by the moisture sensors during the drying of the laundry in two different initial states of quantity/weight and moisture,

FIG. 5 shows an example of a table containing possible values that can be used by the electronic control system to determine the drying cycle end time, while

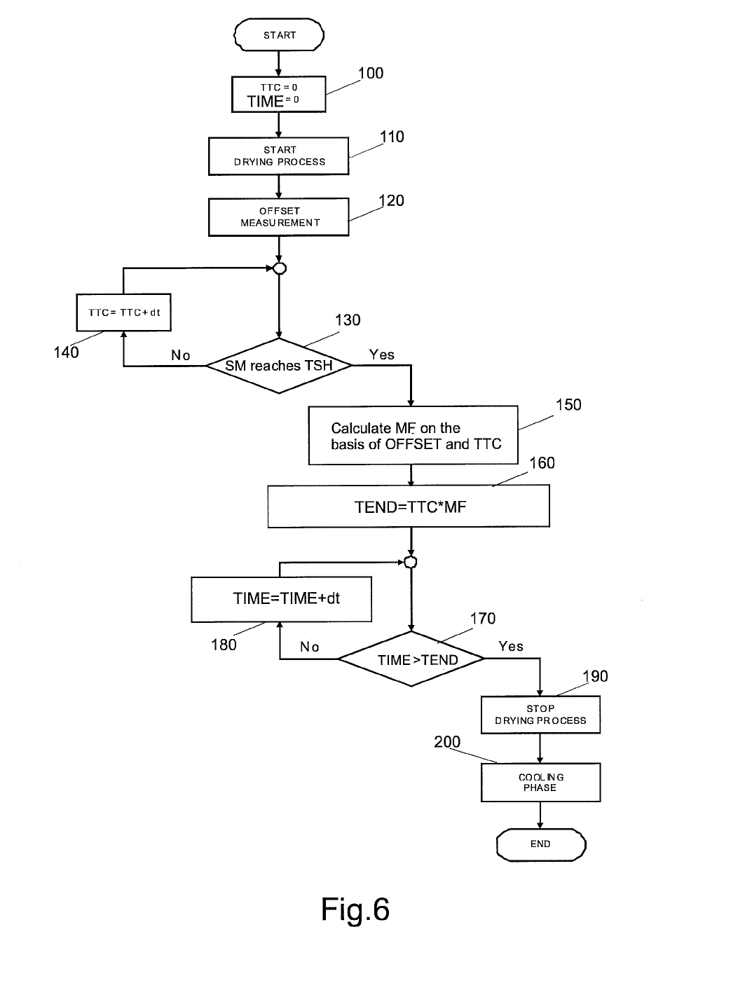

FIG. 6 shows an operation flow chart of the control method implemented by the FIG. 1 rotatable-drum laundry drier.

Number 1 in FIG. 1 indicates as a whole a rotatable-drum laundry drier comprising an outer casing 2 that preferably rests on the floor on a number of feet. Casing 2 supports a rotatable laundry drum 3, which defines a drying chamber 4 for laundry 5 and rotates about a preferably, though not necessarily, horizontal axis of rotation 6. In an alternative embodiment not shown, axis of rotation 6 may be vertical or inclined.

Drying chamber 4 has a preferably frontal access opening 7 closable by a door 8 preferably hinged to casing 2.

Drum 3 may be rotated about axis of rotation 6 by an electric motor, schematically represented in FIG. 1 and indicated with reference number 9, is fed with hot air heated by a heating device, schematically represented in FIG. 1 and indicated with reference number 10, and is fed into drum 3 preferably by a fan schematically represented in FIG. 1 and indicated with reference number 11. Fan 11 may preferably, though not necessarily, be driven by electric motor 9 or, in an alternative embodiment (not shown), by an auxiliary electric motor (not shown) independent of electric motor 9.

In the FIG. 1 example, one opened side of the drum 3 of the laundry drier 1 is advantageously associated, in a rotatable and substantially air-tight way, to a perforated inner wall 12 fixed to a lateral wall of casing 2 and through which hot air flows into drum 3; the other opened side of the drum 3 is advantageously associated, in a rotatable and substantially air-tight way, to a flange 13 associated to casing 2 and interposed between door 8 and front access opening 7 of drum 3.

In the FIGS. 1 and 2 example, flange 13 is fixed firmly to casing 2, and is positioned at front opening 7 so as to project at least partly inside drum 3, so that its inner surface faces the laundry 5 when the latter is loaded into the drum 3.

Heating device 10 may advantageously comprise one or more electric heating components, such as electric resistors (not shown) or, in an alternative embodiment, a heat pump.

In actual use, fan 11 blows a stream of drying air, produced by heating device 10, preferably through perforated inner wall 12 into drum 3. After contacting laundry 5 inside drum 3, the moisture-laden drying air flows out of drum 3 and it is preferably directed to a condensing device 15, which cools the drying air to condense the moisture inside it. For this purpose, condensing device 15 may be supplied with cold air from outside the drier, and feeds the moisture-free air to fan 11. It should be pointed out that condensing device 15 as described above applies, purely by way of example, to one possible embodiment of the present invention, and may be omitted in the case of an exhaust-type rotatable-drum laundry drier 1 (i.e. in which the hot and moisture-laden drying air from the rotatable laundry drum 3 is expelled directly out of rotatable-drum laundry drier 1).

The rotatable-drum laundry drier 1 also comprises an electronic control system 16, which is configured to control the rotatable-drum laundry drier 1, advantageously on the basis of a drying cycle selected by a user via a user control interface 18. The electronic control system 16 is configured to implement, for example, a “special” type” laundry drying cycle such as, for example, a “cushion drying cycle”, or a “duvet drying cycle”, or a “blanket drying cycle”, or a “special” fabrics drying cycle (for example, a drying cycle for laundry made of the material sold with the trademark GORETEX).

The electronic control system 16 advantageously comprises moisture sensors 22 that are configured to generate an electrical signal SM related to the moisture/quantity of the laundry 5 on the basis of contacts between the moisture sensors 22 and the laundry 5; the electronic control system 16 advantageously comprises also an electronic control unit 14, which is preferably configured to control the motor 9, heating device 10 and/or fan 11 in order to regulate the rotation speed of the drum 3, the temperature and/or the flow rate of hot air entering the drum 3 according to the temperature and flow rate specified for the laundry drying cycle selected by the user.

The electronic control unit 14 is advantageously also configured to receive the electrical signal SM related to the moisture/quantity of the laundry 5; estimate/calculate the quantity/weight of the laundry 5 on the basis of a first quantity (called OFFSET and better described in the following) indicatives of the behaviour of the electrical signal SM during a predetermined initial measuring interval TTM of the drying cycle; for example this first quantity may be indicative of the amplitude, or of the frequency or of the period of the electric signal SM related with the moisture/quantity of the laundry 5 during a predetermined initial measuring interval TTM of the drying cycle.

The electronic control unit 14 is advantageously also configured to determine a main cycle interval TTC that is indicative of the time that the electrical signal SM takes from the beginning of the drying cycle to meet a determined relation with a threshold

TSH; for example, if the electrical signal SM is related to the electrical resistance of the laundry 5 detected by the moisture sensors 22, the main cycle interval TCC may be the time that the value of this electrical resistance takes from the beginning of the drying cycle to reach a determined threshold value.

The electronic control unit 14 is advantageously also configured to extend the main cycle interval TTC on the basis of the main cycle interval TTC and the estimated/calculated quantity/weight of laundry, and to terminate the drying cycle at the end of the extended main cycle interval TEND. In other words the electronic control unit 14 is advantageously also configured to calculate the time at which the drying cycle has to be finished, on the basis of the determined main cycle interval TTC and of the estimated/calculated quantity/weight of laundry.

According to a preferred embodiment, shown in FIG. 3, the moisture sensors 22 comprise at least one pair of electrodes 23 configured to make contact with the laundry 5, and an electronic module 24, which is connected to the electrodes 23 and is configured to generate the electrical signal SM related to the moisture/quantity of the laundry 5.

According to a preferred embodiment, shown in FIG. 2, the electrodes 23 may be preferably, but not necessarily, located on the flange 13 in a position facing the inside of the drum 3. In the example described in the following, the electrical signal SM generated by the electronic module 24 is associated with the impedance Z(ti) of the laundry measured between the electrodes 23. Nevertheless, it is obvious that electrical signal SM could be associated, for example, with the resistance and/or conductance of the laundry 5 measured between the electrodes 23.

The electronic control unit 14 may be advantageously configured to calculate the above indicated first quantity, or OFFSET, as the mean value of the amplitude of the signal SM during the predetermined initial measuring interval TTM of the drying cycle, and to calculate the quantity/weight of the laundry 5 on the basis of the OFFSET of the determined measurement signal SM.

Laboratory tests performed by the Applicant have demonstrated that during the predetermined initial measuring interval TTM, the OFFSET of the measurement signal SM varies as a function of the quantity/weight of the laundry inside the drum 3.

In particular, a first factor that influences the OFFSET of the electrical signal SM is the number of contacts between the laundry 5 and the moisture sensors 23, which affects the noise/disturbance in the electrical signal SM. During rotation of the drum 3, the frequency of contact between the laundry 5 and the moisture sensors 22 varies as function of the weight/quantity of the laundry. For example, if the signal SM is related to the amplitude of the electrical resistance of the laundry contacting the moisture sensors 22, and if the quantity/weight of the laundry is low, a small number of contacts and strong electrical noise/disturbance occurs, which increases the OFFSET of the signal SM; in this example, if the quantity/weight of the laundry 5 is, conversely, high, a large number of contacts between the laundry 5 and the moisture sensors 22 cause a low noise/disturbance in the measurement signal SM, which remains substantially unperturbed and consequently has a low OFFSET.

A second factor that influences the OFFSET of the electrical signal SM is the duration of contact between the laundry 5 and the moisture sensors 22. If the signal SM is for example related to the amplitude of the electrical resistance of the laundry contacting the moisture sensors 22, laundry of low quantity/weight entails a short duration for electrodes-laundry contact, which gives rise to large disturbance of the electrical signal SM and causes a high OFFSET; in this example laundry of high quantity/weight is, conversely, subject to an extended duration of contact that causes minimal disturbance of the electrical signal SM and a low OFFSET.

Two graphs are shown by way of example in FIG. 4, indicating with A1 and B1 the electrical signal SM during the drying cycle performed on the laundry 5 characterized by a first and respectively second initial load condition.

The first condition (graph A1) relates to a laundry load of low weight P1, e.g. 1 Kg, and initial moisture M1 equal to 60% of the weight of the load, while the second condition (graph B1) relates to a laundry load of high weight P2>P1, e.g. 8 Kg, and initial moisture M2=M1 equal to 60% of the weight of the load.

From the aforesaid graphs, it can be noted that during the initial measuring interval TTM, the OFFSET of the electrical signal SM is associated with the weight/quantity of the laundry 5. In particular, as anticipated above, the low weight/quantity of the loaded laundry causes strong disturbance (indicated by A2 in FIG. 4) on the electrical signal A1, which increases the OFFSET, while a high weight/quantity load causes weak disturbance (indicated by B2) on the electrical signal B 1, which has a negligible effect on the OFFSET (it is underlined that the actual signals generated by the electrodes are represented respectively by graphs A2 and B2, while graphs A1 and B1 represent respectively the mean value of the actual signals).

It should also be pointed out that the estimation/calculation of the quantity/weight of the laundry on the basis of the mean value of the signal SM during the initial measuring interval TTM (i.e. the OFFSET value) is found to be a satisfactorily “robust” estimate, i.e. it can be implemented on different types of rotatable-drum home driers independently of the geometry of the electrodes 23 utilized, without needing actions for changing the configuration of the electronic control unit 14 and/or the electronic modules that interface the electrodes 23 with the electronic control unit 14. In fact, the OFFSET value remains within predetermined ranges independently of the geometry of the electrodes. Therefore, the electronic control system is configured on the basis of the said ranges and is thus suitable for being implemented on many types of driers. Instead, in known systems, the quantity/weight of the laundry is determined on the basis of the noise/disturbance expressly filtered from the electrical signal generated by the moisture sensors. Since, unlike the mean value of the signal SM that, as described above, always remains within a configuration range, and that the range of noise variation heavily depends on the geometry of the electrodes, it follows that known electronic control systems are not suitable for being applied to driers having electrodes with geometries different from those used for the initial calibration, without requiring specific calibration of the system itself.

According to a preferred embodiment, the rotatable-drum laundry drier 1 advantageously comprises, preferably within the electronic control unit 14, memory means (not shown) configured to contain (in a table for example): a plurality of first values, each of which is indicative of an OFFSET value or range of values and is associated with a laundry quantity/weight; a plurality of second values, each of which is indicative of a main cycle interval TTC and is associated with a corresponding OFFSET value or range of values; and a plurality of third values, each of which is indicative of a multiplication factor MF and is associated with a corresponding value or range of values of main cycle interval TTC and a related OFFSET value or range of values, i.e. to a laundry quantity/weight.

The electronic control unit 14 is also advantageously configured to:
determine the multiplication factor MF on the basis of the OFFSET value measured during the initial measuring interval TTM and of the value of the main cycle interval TTC, and
extend the main cycle interval TTC on the basis of the multiplication factor MF, i.e. calculate the cycle end time TEND according to the following relation: TEND=MF*TTC.

The measurement time interval TTM may be preferably included between 1 minute and 5 minutes, and preferably be equal to approximately 2 minutes.

FIG. 5 shows, by way of example, a table stored in the memory means containing the first, second and third values, respectively indicated as VAL1, VAL2 and VAL3, where VAL1 comprises for example two OFFSET ranges, the first of which (0<=OFFSET<=1500) is for example associated with a laundry load of LOAD=LOAD1=2.7 Kg (corresponding, for example, to a double duvet), whilst the second OFFSET range (1500<OFFSET) is for example associated with a laundry load of LOAD=LOAD2=1 Kg (corresponding, for example, to a single duvet). The table also comprises, for example, a first and a second series of ranges of value of main cycle intervals VAL2=TTC associated with the first and second OFFSET ranges respectively.

The third value VAL3 comprises respectively three and two multiplication factors MF associated for example with a corresponding range of values of the main cycle interval TTC (VAL2) of the first and second series of OFFSETs (VAL1).

With reference to the example shown in the table in FIG. 5, during use, the electronic control unit 14 might, for example, determine whether the laundry load corresponds to a “single” or “double duvet” depending on the OFFSET measured in the measurement interval TTM, determine the main cycle interval TTC, determine the multiplication factor MF based on the main cycle interval TTC and on the OFFSET, and calculate the drying cycle end time TEND by multiplying the main cycle interval TTC by the multiplication factor MF. For example, if OFFSET=1000 and the main cycle interval measured is TTC=25 minutes, the electronic control unit 14 may determine that the laundry load corresponds to a “double duvet”, that the multiplication factor is 8 and that the drying cycle end time TEND=25(minutes)*8=200 minutes.

With reference to FIG. 6, an example of the operations implemented by the control method implemented by the electronic control system 16 made according to the principles of the present invention shall now be described.

In the initial phase, the electronic control unit 14 initializes two control variables, TTC=0 associated with the main cycle interval TTC, and TIME=0 indicating the time elapsed from the start of the drying cycle (Block 100) and, at the same time, starts the drying cycle (Block 110) during which it controls the electric motor 9 to rotate the drum 3 and controls the heating device 10 and the fan 11 to ensure that the flow of hot air enters the rotating drum 3.

During the initial measuring interval TTM, the electronic control unit 14 determines the OFFSET, on the basis of the electrical signal SM generated by the electrodes 23 (Block 120) and at predetermined intervals dt, and checks if the first quantity associated with the electrical signal SM has reached the predetermined threshold TSH (Block 130).

In the negative case (NO output from Block 130), the electronic control unit 14 increments the variable TTC=TTC+dt and repeats the check performed in Block 130.

In the positive case (YES output from Block 130), the electronic control unit 14 determines the quantity/weight of the laundry 5 on the basis of the OFFSET and determines the multiplication factor MF on the basis of the laundry quantity/weight, i.e. on the basis of the OFFSET and variable TTC (Block 150) corresponding to the interval where the electrical signal SM meets relation in Block 130.

The electronic control unit 14 determines the drying cycle end time TEND by multiplying variable TTC by the multiplication factor MF (Block 160).

The electronic control unit 14 checks, instant by instant, whether the TIME variable has reached the drying cycle end time TEND (Block 170) and, if not (NO output from Block 170), increments the TIME variable by interval dt (TIME=TIME+dt; Block 180), while if so (YES output from Block 170), it interrupts the drying cycle (Block 190).

Preferably, but not necessarily, the electronic control unit 14 may stop the drying cycle (Block 190) and start a laundry-cooling stage (200).

Stopping the drying cycle (block 190) may preferably comprise turning off heating device 10.

The purpose of the cooling stage is to lower the high temperature (e.g. 70° C.) of the laundry to a predetermined low temperature (e.g. 50° C.) at which laundry 5 can be handled by the user. At the cooling stage, drum 3 may be kept turning, and non-heated air fed into drum. And electronic control unit 14 may advantageously be configured to: calculate the weight/quantity of the laundry 5 on the basis of the OFFSET determined in the initial measuring interval TTM through the stored table; and adjust the duration of the cooling phase as a function of the calculated weight/quantity of the laundry.

For this purpose, electronic control unit 14 may comprise test data stored in a table, and by which to determine the length of the cooling stage for each quantity/weight of laundry 5.

Regarding what has been described above, it should be pointed out that the above-described control method may advantageously be encoded in software that can be loaded in the electronic control unit 14 of the rotatable-drum laundry drier 1 and designed to ensure that, when executed, the electronic control unit 14 becomes configured for controlling the rotatable-drum laundry drier 1 according to the provisions of the method.

The above-described method is extremely advantageous as, in addition to being implementable in a rotatable-drum laundry drier 1, it enables uniform final drying to be achieved both inside and on the outside of the laundry, even when the latter corresponds to a type of laundry characterized by a different inner/outer drying capacity and/or is made of a so-called “special” fabric.

The above-described method is also advantageous as, thanks to the indirect estimate/calculate of the weight/quantity of laundry on the basis of the OFFSET of the electrical signal, it is possible to adequately adjust the final cooling interval of the laundry.

Clearly, changes may be made to the rotatable-drum laundry drier as described and illustrated herein without, however, departing from the scope of the present invention.

1. A method of controlling a rotatable-drum laundry drier comprising a drum for loading laundry, and moisture sensors generating an electrical signal related to the moisture/quantity of the loaded laundry, said method comprising the steps of:
feeding drying air into the drum;
rotating the drum about an axis of rotation;
calculating the quantity/weight of the laundry on the basis of a first quantity related to the behaviour of the electrical signal in a predetermined initial measuring interval of the drying cycle;
calculating a main cycle interval related to the time that the electrical signal takes from the beginning of the drying cycle to meet a determined relation with a threshold;
extending the main cycle interval on the basis of the calculated quantity/weight of the laundry and of the determined main cycle interval; and
stopping the drying cycle at the end of the extended main cycle interval.

2. A method according to claim 1, wherein said first quantity is indicative of the mean value of the amplitude of said electrical signal during said predetermined initial measuring interval.

3. A method according to claim 1, wherein the initial measuring interval is between approximately 1 and 5 minutes.

4. A method according to claim 2, wherein the initial measuring interval is approximately 2 minutes.

5. A method according to claim 1, further comprising the step of storing in memory means of said rotatable-drum laundry drier:
a plurality of first values, each of which is associated to a value or range of values of said first quantity;
a plurality of second values, each of which is indicative of a main cycle interval and is associated with a value or range of values of said first quantity; and
a plurality of third values, each of which is indicative of a multiplication factor and is associated with a value or a range of values of said main cycle interval and with a value or range of values of said first quantity.

6. A method according to claim 5, further comprising the steps of:
determining a first value on the basis of the value of said first quantity measured during the initial measuring interval;
determining a second value on the basis of the calculated main cycle interval;
determining a third value, corresponding to a multiplication factor, on the basis of said determined first and second values; and
extending said main cycle interval by multiplying said main cycle interval by said determined third value associated with said multiplication factor.

7. A method according to claim 6, further comprising the step of calculating the quantity/weight of laundry as a function of said first value, and adjusting the duration of a cooling phase of the laundry following the drying cycle end time as a function of the calculated weight/quantity of the laundry.

8. A rotatable-drum laundry drier comprising:
a rotatable drum for laundry,
moisture sensors configured to generate an electrical signal related to the moisture/quantity of the laundry,
feeding drying air means for feeding drying air into the drum, and
means for rotating the drum about an axis of rotation;
wherein said rotatable-drum laundry drier comprises electronic control means configured to:
calculate the quantity/weight of the laundry on the basis of a first quantity indicative of the behaviour of the electrical signal in an predetermined initial measuring interval of the drying cycle;
determining a main cycle interval indicatives of the time that the electrical signal takes from the beginning of the drying cycle to meet a determined relation with a threshold;
extending the main cycle interval on the basis of the calculated quantity/weight of the laundry and the determined main cycle interval, and
stopping the drying cycle at the end of the extended main cycle interval.

9. A rotatable-drum laundry drier according to claim 8, wherein said electronic control means are configured to calculate the quantity/weight of the laundry on the basis of a first quantity that is indicative of the mean value of the amplitude of said electrical signal (SM) during said predetermined initial measuring interval.

10. A rotatable-drum laundry drier according to claim 9, wherein the initial measuring interval is between approximately 1 and 5 minutes.

11. A rotatable-drum laundry drier according to claim 10, wherein the initial measuring interval is approximately 2 minutes.

12. A rotatable-drum laundry drier according to claim 8, further comprising memory means containing:
a plurality of first values, each of which is associated to a value or range of values of said first quantity;
a plurality of second values, each of which is indicative of a main cycle interval and is associated with a value or range of values of said first quantity;
a plurality of third values, each of which is indicative of a multiplication factor and is associated with a value or a range of values of said main cycle interval and with said value or range of values of said first quantity.

13. A rotatable-drum laundry drier according to claim 12 wherein said electronic control means are configured to:
determine a first value on the basis of the value of said first quantity measured during the initial measuring interval;
determine a second value on the basis of the calculated main cycle interval;
determine a third value, corresponding to a multiplication factor, on the basis of said determined first and second values; and
extend said main cycle interval by multiplying said main cycle interval by said determined third value associated with said multiplication factor.

14. A rotatable-drum laundry drier according to claim 13, wherein said electronic control means are configured to calculate the quantity/weight of laundry as a function of said first value, and to adjust the duration of a cooling phase of the laundry following the drying cycle end time as a function of the calculated weight/quantity of the laundry.

15. An electronic control system of a rotatable-drum laundry drier comprising electronic control means configured to implement the control method as claimed in claim 1.

16. An electronic control system of a rotatable-drum laundry drier comprising electronic control means configured to implement the control method as claimed in claim 2.

17. An electronic control system of a rotatable-drum laundry drier comprising electronic control means configured to implement the control method as claimed in claim 5.

18. An electronic control system of a rotatable-drum laundry drier comprising electronic control means configured to implement the control method as claimed in claim 3.

19. An electronic control system of a rotatable-drum laundry drier comprising electronic control means configured to implement the control method as claimed in claim 6.

20. An electronic control system of a rotatable-drum laundry drier comprising electronic control means configured to implement the control method as claimed in claim 7.
